(19) United States
(12) Patent Application Publication
(10) Pub. No.: US 2005/0211608 A1
(43) Pub. Date: Sep. 29, 2005

(54) Pressure regulator and filter for irrigation systems

(75) Inventor: George Henry Lockwood, Pompano Beach, FL (US)

Correspondence Address: FITCH EVEN TABIN AND FLANNERY, 120 SOUTH LA SALLE STREET, SUITE 1600, CHICAGO, IL, 60603-3406, US

(73) Assignee: RAIN BIRD CORPORATION

(21) Appl. No.: 11/088,486

(22) Filed: Mar. 24, 2005

Related U.S. Application Data
(60) Provisional application No. 60/557,444, filed on Mar. 29, 2004.

(51) Int. Cl. B01D 35/00

(52) U.S. Cl. 210/106; 210/413

(57) ABSTRACT

A control device for use with irrigation systems includes one or more of a solenoid-actuated valve, a pressure regulating valve, and a self-cleaning filter assembly. For example, the solenoid-actuated valve commands a small stream of control water to set the on/off condition of the irrigation system and to control a wiper used to clean the surface of a filter. The filter assembly is upstream from the solenoid-actuated valve and any pressure regulating valve and filters the flow of water to both, removing debris and particulate matter from a source of irrigation water. When the irrigation system is turned on by opening the solenoid-actuated valve, a control chamber in the self-cleaning filter assembly becomes pressurized in response to a flow of control water from the solenoid-actuated valve. The pressure drives a shaft which causes the wiper to scrape across the filter surface. During the stroke of the shaft, one or more grooves in the shaft provide a pathway for unfiltered water to remove particulate matter from the filter assembly. When the system is turned off, the control chamber depressurizes and a spring drives the shaft upward, scraping the filter screen in the opposite direction. Filtered water flows from the filter assembly to a conventional pressure regulating valve. The pressure regulating valve includes a lockout chamber and piston. When the solenoid-actuated valve is closed, a flow of control water pressurizes the lockout chamber and causes a flow valve in the pressure regulating valve to close, shutting down the irrigation system.

### CROSS-REFERENCE TO RELATED APPLICATION

This application claims priority to United States Provisional Application Ser. No. 60/557,444, filed Mar. 29, 2004, and entitled “PRESSURE REGULATED SOLENOID VALVE.”

### FIELD OF THE INVENTION

The present invention generally relates to control devices for use with irrigation systems and, more particularly, to a pressure regulator and filter for an irrigation system.

### BACKGROUND OF THE INVENTION

Irrigation systems are used to provide water to a wide variety of devices, including, for example, spray nozzles, sprinkler heads, and drip hoses. Such systems generally make use of control valves to command the flow of water through the system, pressure regulators to even out variations in source water pressure, and filters to remove debris and particulate matter from the water flow.

Solenoid controlled on/off valves for use in irrigation systems are well known. For example, a solenoid-actuated valve uses a solenoid to command a small flow of control water, which, in turn, controls a larger flow of water to attached irrigation devices. Such solenoid-actuated valves often include relatively small passageways for the flow of control water and require the filtering of the control water to insure the removal of particulate matter which could block flow through the relatively small passageways. A filter may be placed upstream to filter the control water stream.

Water filters are also used in a wide range of applications to remove particulate matter from an irrigation water flow stream. Irrigation water supplies may contain fine particulate matter and debris capable of obstructing flow through sprinkler heads or low-flow emitter devices such as drip hoses. Thus, it is necessary to filter the irrigation water supply upstream of attached irrigation devices.

The aggregation of material on the upstream side of a filter can lead to a pressure drop across the filter medium and can significantly reduce water flow through the filter and adversely impact the performance of the irrigation system. Thus, it is also beneficial to be able to clean the filter medium. One known device uses scraper blades to clean the upstream surface of a filter each time the solenoid-actuated valve is opened or closed. Another known device is a self-cleaning filter device which is placed downstream from a control valve. This device filters the irrigation water stream and automatically cleans and back washes a filter on each on and off cycle of an upstream control valve.

Prior irrigation devices provide filters for the irrigation water or for the control water, but not both. Irrigation control devices and filters are generally located in the field, and it can be inconvenient and costly to manually clean the filters and purge them of debris and other particulate matter. Thus, there is a need for an improved self-cleaning filter assembly which cleans a filter on each on and off cycle of a control valve and which filters both the control water for use by a control valve and the irrigation water for use by the irrigation system.

### BRIEF DESCRIPTION OF THE DRAWINGS

FIG. 1 is a cross-sectional view of a self-cleaning filter, a pressure regulator, and a solenoid-actuated valve embodying features of the present inventions;

FIG. 2 is a cross-sectional view of the self-cleaning filter assembly of FIG. 1 in the flow on condition; and

FIG. 3 is a cross-sectional view of the pressure regulator assembly of FIG. 1 in the flow on condition.

### DETAILED DESCRIPTION OF THE PREFERRED EMBODIMENT(S)

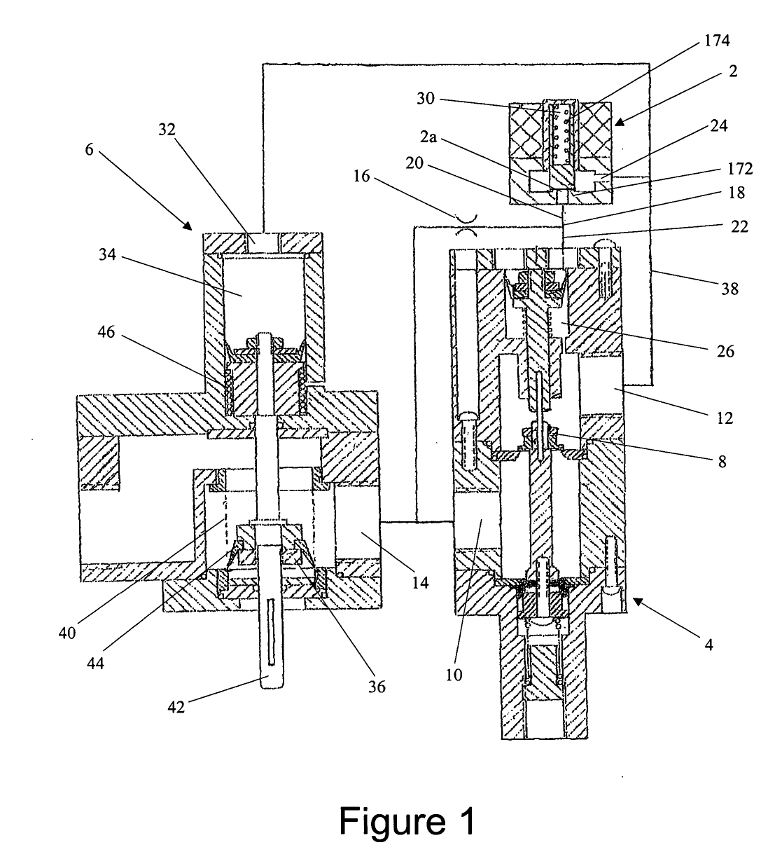

With reference to FIG. 1, there is illustrated a solenoid-actuated valve 2, a pressure regulating valve 4, and a self-cleaning filter assembly 6, as an exemplary embodiment employing features in accordance with the present invention. These components are used to control fluid flow, such as water to an irrigation system. The solenoid-actuated valve 2 turns the flow in the irrigation system on or off by controlling a flow valve 8 in the pressure regulating valve 4. The pressure regulating valve 4 maintains water pressure stability between an inlet 10 and an outlet 12 of the valve 4. A self-cleaning filter assembly 6 is located upstream of both the solenoid-actuated valve 2 and the pressure regulating valve 4. Thus, water flow to both the solenoid-actuated valve 2 and the pressure regulating valve 4 is filtered to remove foreign matter that may otherwise interfere with the operation of the solenoid-actuated valve 2, the pressure regulating valve 4 or the irrigation system downstream. Although FIG. 1 illustrates the combination of the self-cleaning filter assembly 6 and the pressure regulating valve 4, other exemplary embodiments may use these components independently and still employ aspects in accordance with the present invention.

The solenoid-actuated valve 2 is used to control the flow between its on and off state of the irrigation system. The solenoid-actuated valve 2 is located downstream of the filter assembly 6. A portion of the flow of filtered water from the filter assembly outlet 14 is directed to a flow restrictor 16. The flow restrictor 16 limits the flow of filtered water to a very low rate, for example, less than ten gallons/hour. The output of the flow restrictor is directed to a T-connection 18 from which it can flow through passage 20 to the solenoid-actuated valve inlet 2a or through passage 22 to a two-way port 162 of a lockout chamber 26 of the pressure regulating valve 4.

The solenoid-actuated valve 2 includes a plunger valve 170 and a valve seat 172. In the flow “off” condition, the solenoid 30 is de-energized, and a spring 174 biases the plunger valve 170 into engagement with the valve seat 172 to shut off flow through the solenoid-actuated valve 2 between the inlet 2a and the outlet 24. This causes all of the water flowing from the restrictor 16 to flow into the lockout chamber 26. The flow into the lockout chamber 26 causes it to become pressurized, which forces a lockout piston shaft 28 in the chamber 26 to move downward to close the flow valve 8.

In the flow “on” condition, the solenoid 30 is energized to retract the plunger valve 170 and remove it from the valve seat 172 to open the solenoid-actuated valve 2. This allows flow through the solenoid-actuated valve 2 to the outlet 24. A portion of the flow from the solenoid-actuated valve outlet 24 is directed to a two-way port 32 of a control chamber 34 of the self-cleaning filter assembly 6. That flow pressurizes the control chamber 34 and causes the wiper assembly 36 to move to its downward position as described below. The remainder of the flow from the solenoid-actuated valve outlet 24 is directed to the irrigation system via passage 38.

During the normal course of operation, the irrigation system will cycle between flow “off” and flow “on” conditions. The control chamber 34 in the self-cleaning filter assembly 6 acts to operate the wiper assembly 36 to scrape the surface of a filter screen 40, in a manner described below, when the system transitions between the flow “off” and flow “on” conditions. When the irrigation system is switched on, a small flow of control water enters the control chamber 34 through the port 32, pressurizing the chamber 34 and urging a shaft 42 and wiper assembly 36 to a downward position. This movement causes the wiper 44 to scrape accumulated particulate matter from the upstream surface of the filter screen 40. When flow in the system is switched off, control water ceases to flow into the control chamber 34, and so, the control chamber 34 becomes depressurized. This depressurization allows a spring 46 to urge the shaft 42 and wiper assembly 36 into an upward position. This movement causes the wipter 44 to scrape the upstream surface of the filter screen 40 in the opposite direction.

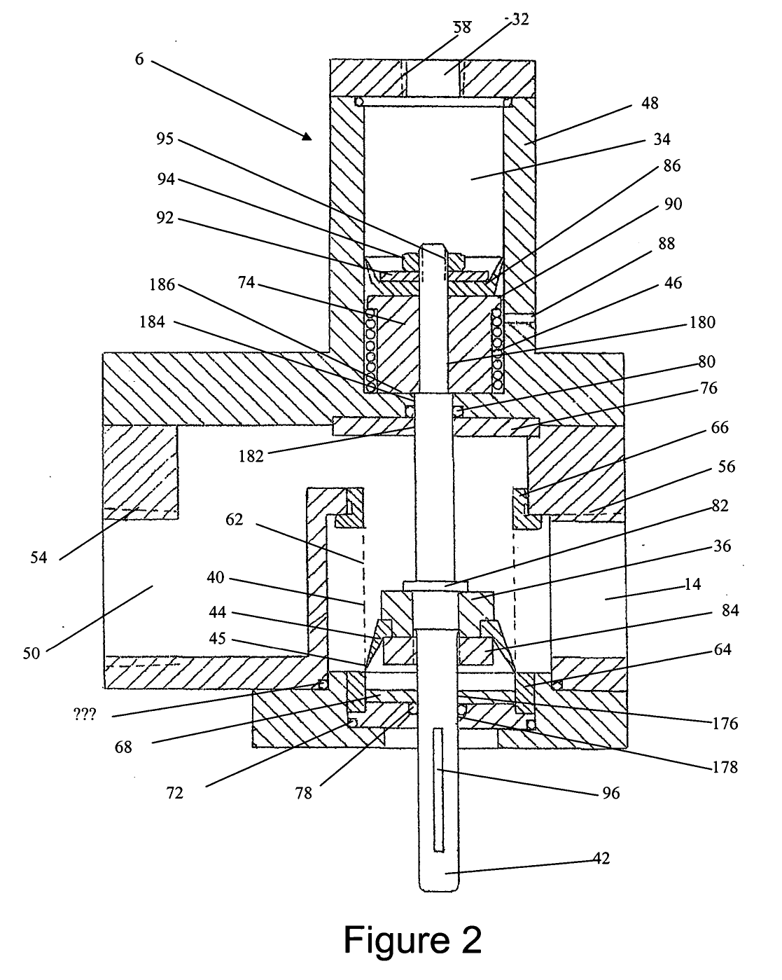

With reference to FIG. 2, the filter assembly 6 has a body 48 defining an inlet 50, an outlet 14 and a fluid flow passage 52 extending between the inlet 50 and the outlet 14. The inlet 50 and outlet 14 are designed for connection to piping or other conduit, such as by threads 54 and 56, respectively, or by friction engagements. The fluid flow passage 52 allows water to flow through the filter assembly 6. The filter screen 40 is located in the passage 52 to filter water that flows through the passage 52. The filter assembly body 48 also defines the cylindrical control chamber 34 having the two-way port 32. The port 32 is adapted for connection to a source of control water using threads 58, as shown, or a friction connection. An exit port 60 in the filter assembly body 48 allows filtered particulate matter to be discharged from the filter assembly 6 as described below.

The filter screen 40 preferably is comprised of a plastic or metallic material that defines a mesh of openings 62. Although the filter screen 40 may take on many different configurations and shapes, the preferred filter screen has a hollow, generally cylindrical shape. The filter screen 40 includes a lower end support 64 and an upper end support 66 to aid in maintaining the shape of the filter screen 40 and to aid in mounting the filter screen 40 in the filter assembly body 48. The lower end support 64 and the upper end support 66 are preferably comprised of plastic or metallic material.

A bottom cap 68 fits inside the lower end support 64 and defines a hole 176 sized to receive the shaft 42. The bottom cap 68 fits into a bottom guide plate 70 defining a hole 178 in alignment with the hole 176 in the bottom cap 68. The hole 178 also is sized to receive the shaft 42. An o-ring 72 provides a water tight seal between the bottom guide plate 70 and the filter assembly body 48.

The round shaft 42, capable of reciprocating motion, extends from the control chamber 34 through a hole 180 defined by a spacer 74 in the control chamber 34. The shaft 42 then extends through a hole 182 defined by a top guide plate 76, along a central axis of the filter screen 40, through the hole 176 in the bottom cap 68, and through the hole 178 in the bottom guide plate 70. The lower end of the shaft 42 exits the filter assembly body 48 through the exit port 60. O-rings 78 and 80 provide water tight seals around the shaft 42 above the bottom guide plate 70 and below the top guide plate 76, respectively.

The wiper 44 is fixed on the shaft 42 and reciprocates within the filter screen 40. The wiper 44 preferably has a frusto-conical shape with an annular knife edge formed by its downward-facing, larger diameter edge 45. The outside diameter of the wiper 44 is selected so that the wiper 44 will maintain contact with the filter screen 40 along the entire outside edge 45 of the wiper 44. The wiper 44 preferably is made from a rigid material. The wiper assembly 36 is fixed to the shaft 42 by means of a stop 82 and a locking nut 84.

The control chamber 34 is used to control the position of the wiper assembly 36 through the development of forces which reciprocate the shaft 42 along its longitudinal axis. The control chamber 34 is preferably in the shape of a cylinder. The central axis of the control chamber 34 is aligned with the central axis of the filter screen 40. A passage 184, sized to receive the shaft 42, connects the control chamber 34 to the fluid flow passage 52. The spring 46 is situated about the spacer 74 and between an upper annular flange 90 of the spacer 74 and a bottom 186 of the control chamber 34. The spring 46 provides an upward biasing force on a piston seal 86 to move the shaft 42 and the wiper 44 upward. The piston seal 86 also transmits hydraulic forces to the shaft 42 when the control chamber 34 is pressurized by a flow of control water to move the wiper 44 in the other direction. The body 48 defines a vent hole 88 extending through the body 48 of the filter assembly 6 from the control chamber 34 below the piston seal 86 to outside of the filter assembly 6 to atmosphere. The vent hole 88 insures that the pressure beneath the piston seal 86 will remain atmospheric and allows the piston seal 86 to reciprocate in the control chamber 34.

More specifically, the spring 46 has a diameter sized to fit inside the control chamber 34 cylinder and has one end resting on the bottom surface 186 of the control chamber 34. The spacer 74 preferably has a cylindrical shape. The upper annular flange 90 of the spacer 74 rests on the top end of the spring 46. The spring 46 is preferably a helical spring, and the diameter of the cylindrical portion of the spacer 74 is such that it fits inside the spring 46 and provides lateral support for the spring 46 while not impeding axial motion of the spring 46. The diameter of the circular flange 90 is selected so that it small enough to fit inside the control chamber 34 without causing excessive friction with the sides of the control chamber 34 while being large enough to retain the spring 46. The bias of the spring 46 is chosen so that in the absence of a predetermined hydraulic pressure from above, such as when the system is in a flow off condition, the spring 46 will urge the spacer 74, and thus, the piston seal 86 and shaft 42, to an upward position.

The piston seal 86 is fixed to the shaft 42 above the spacer 74 and is held in place by a mounting washer 92 and a locking nut 94, which may be attached to the shaft 42 by threads 95 along the upper end of the shaft 42. The piston seal 86 provides an essentially watertight seal with the control chamber 34. Hydraulic forces generated by control water flowing into the control chamber 34 through the port 32 when the irrigation system is in a flow “on” condition will urge the piston seal 86 downward against the bias of the spring 46, thereby compressing the spring 46 and causing the shaft 42 to move downward.

Filtered particulate matter is discarded from the filter assembly 6 via one or more grooves 96 defined by the lower region of the shaft 42. The grooves 96 are positioned axially along the shaft 42 so that when the shaft 42 is in its extreme upward position, the grooves 96 reside entirely above the bottom guide plate 70, and the o-ring 98 seals against the shaft 42. When the shaft 42 is in its extreme downward position, the grooves 96 reside entirely below the bottom guide plate 70, and the o-ring 98 again seals against the shaft 42. However, when the shaft 42 is in an intermediate position, such as during the upward or downward stroke of the shaft 42, the grooves 96 bridge the bottom cap 68 and the bottom guide plate 70 and create a passage for the flow of particulate matter and unfiltered water out of the filter assembly 6.

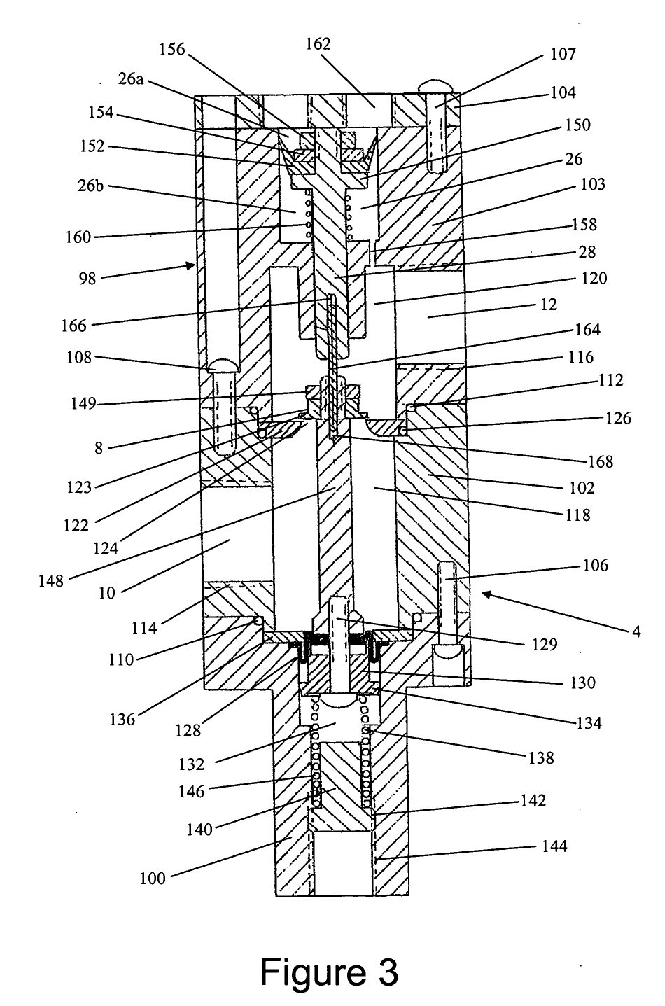

With reference to FIG. 3, the pressure regulating valve 4 has a main body 98 defining an inlet 10 and an outlet 12. The main body 98 is preferably constructed in four segments 100, 102, 103 and 104, which may be joined by a number of screws, 106,107 and 108, and sealed together by o-rings 110 and 112. The inlet 10 and the outlet 12 are designed for connection to piping or other conduit, such as by threads 114 and 116, respectively, or by friction engagements. The pressure regulating valve 4 comprises three main chambers defined by the body 98: a system pressure chamber 118; an outlet chamber 120; and the lockout chamber 26.

The system pressure chamber 118 is separated from the outlet chamber 120 by a valve seat 122 which defines an aperture 124. An o-ring 126 provides a water tight seal between the valve seat 122 and the main body 98. At the opposite end of the system pressure chamber 118 from the valve seat 122, there is a rolling diaphragm 128. The rolling diaphragm 128 is supported in an axially displaceable manner by a spacer 130 which can reciprocate in a spring chamber 132. A flange 134 on the spacer 130, and a bottom plate 136 of the system pressure chamber 118 prevent the upward motion of the spacer 130 into the system pressure chamber 118. The spacer 130 is supported by a spring 138. The spring 138 biases the spacer 130 and rolling diaphragm 128 upward toward the system pressure chamber 118. The amount of spring bias is preselected by the position of an adjustment bolt 140, which can be turned to move the position of the bottom end of the spring 138. The further the adjustment bolt 140 is turned into the main body 48, the greater the spring 138 is pre-loaded and, thus, the greater the spring bias. The adjustment bolt 140 includes a larger diameter threaded portion 142 for engagement with threads 144 on the spring chamber 132 and a smaller diameter portion 146 which fits inside the spring 138. The spring is preferably a helical spring.

A pressure regulator shaft 148 is mounted to the rolling diaphragm 128. A screw 129 fixes the spacer 130 to the pressure regulator shaft 148. The pressure regulator shaft 148 extends through the aperture 124 in the valve seat 122 and into the outlet chamber 120. The flow valve 8 is fixed to the pressure regulator shaft 148 and held in place by a locking nut 149 and includes a valve head 123 sized to seat on the valve seat 122 to seal the aperture 124 when the diaphragm 128 and shaft are in their downward positions designed to prohibit flow through the valve 4. The flow valve head 123 and the rolling diaphragm 128 are sized such that the hydraulic force on the diaphragm 128 generated by the pressure of water in the system pressure chamber 118 will be greater than the hydraulic force on the flow valve head 123.

More specifically, the pressure regulating function of the regulator valve 4 is performed by the interaction of the inlet water pressure, the rolling diaphragm 128, the spring 138 and the flow valve 8. When the inlet water pressure is at or below a predetermined value as determined by the position of the adjustment bolt 140, the hydraulic force on the rolling diaphragm 128 due to the water in the system pressure chamber 118 is overcome by the spring 138 bias, causing the rolling diaphragm 128 and thus, the pressure regulator shaft 148, to be in a raised position, holding the flow valve 8 open and allowing free flow of water to the outlet chamber 120. If the inlet water pressure increases above the predetermined value, the pressure on the rolling diaphragm 128 will overcome the force of the spring 138 bias and cause the diaphragm 128 to move downward, partially closing off the flow valve 8, reducing flow to the outlet chamber 120, and thereby causing a reduction in the water pressure in the outlet chamber 120.

The flow valve 8 also functions as an on/off valve. A lockout piston shaft 28 extends from the lockout chamber 26 into the outlet chamber 120 and is capable of reciprocating motion. The lockout piston shaft 28 includes an upper annular flange 150 and a piston seal 152. The piston seal 152 may be mounted to the shaft 28 using a washer 154 and a locking nut 156. The piston seal 152 provides an essentially water tight fit with the lockout chamber 26, dividing the chamber 26 into an upper portion 26a above the seal and a lower portion 26b below the seal 152. A vent port 158 provides fluid communication between the lower portion 26b of the lockout chamber 26 and the outlet chamber 120, enabling pressure equalization between the lower portion 26b of the lockout chamber 26 and the outlet chamber 120.

The pressure of the control water in the upper portion 26a of the lockout chamber 26 determines the position of the lockout piston shaft 28. The lockout piston shaft 28 is biased towards an upward position by a lockout spring 160. The preferred lockout spring 160 is a helical spring that surrounds a portion the lockout piston shaft 28. One end of the lockout spring 160 rests against the bottom surface 27 of the lockout chamber 28 and the other end presses against the upper annular flange 150 of the lockout piston shaft 28.

When the solenoid-actuated valve 2 is open, control water can flow freely through the solenoid-actuated valve 2 to join the flow from the outlet chamber 120 via the passage 38, and to the port 162 of the lockout chamber 26 via the passage 22. Thus, the control water supplied to the port 162 of the lockout chamber will essentially be at the same pressure as the outlet water pressure. In this situation, the net hydraulic force on the lockout piston seal 152 will be zero, and the bias of the spring 160 will hold the lockout piston shaft 28 in an upward position.

When the solenoid-actuated valve 2 is closed, the entire flow of control water from the restrictor 16 is directed into the lockout chamber 26 via the port 162. This flow pressurizes the upper portion 26a of the lockout chamber 26, forcing the lockout piston shaft 28 downward.

The lockout piston shaft 28 is linked to the pressure regulator shaft 148 by a slideable pin 164. The bottom portion of the lockout piston 28 and the top portion of the pressure regulator shaft 148 have central axial bores 166 and 168 aligned with each other and sized to receive the slidable pin 164. The depth of the bores 166 and 168 and the length of the slideable pin 164 are determined so as to allow vertical play when the lockout piston shaft 28 is in its extreme upward position, so that the regulator 4 can control the pressure in the outlet chamber 120 by varying the spacing between the valve head 123 and the valve seat 122 More specifically, when the solenoid-actuated valve 2 is open and the system is in a flow “on” condition, the lockout piston shaft 28 is in an upward position, and the vertical play in the slideable pin 164 allows the pressure regulator shaft 148 to move freely in conjunction with the rolling diaphragm 128. This allows the flow valve 8 to function as a pressure regulating valve. The pin 164 also allows the lockout piston shaft 28 to move downward and engage the pressure regulator shaft 148 until the flow valve 8 closes off when then lockout piston shaft 28 moves to an extreme downward position. The slideable pin 164 is sufficiently long so as to remain engaged in the bores 166 and 168 of both the lockout piston shaft 28 and the pressure regulator shaft 148 at all times during operation of the pressure regulator 4.

When the solenoid-actuated valve 2 is closed, the system is in a flow “off” condition and the upper portion 26a of the lockout chamber 26 will be pressurized, forcing the lockout piston shaft 28 to a downward position. In this condition, the slidable pin 164 is forced against the pressure regulating shaft 148, causing the flow valve 8 to close and shut off flow to the irrigation system.

The foregoing relates to a preferred exemplary embodiment of the invention. It is understood that other embodiments and variants are possible which lie within the spirit and scope of the invention as set forth in the following claims.

1. An apparatus for use in controlling fluid flow comprising:
a pressure regulator defining a first inlet, a first outlet and a first passageway extending therebetween and having a first valve and a first valve seat in the first passageway, the first valve being moveable into engagement with the first valve seat to close the first passageway to prohibit fluid flow therethrough and various other positions spaced from the first valve seat to regulate flow through the first valve seat;
a filter assembly defining a second inlet, a second outlet and a second passageway extending therebetween, the second outlet is in fluid communication with the first inlet of the pressure regulator to filter the fluid entering the pressure regulator, and having a filter element and a wiper engaging the filter element to clean the filter element; and
a control device being in communication with the pressure regulator and the filter assembly and having at least two settings, a first setting causing the first valve to engage the first valve seat to prohibit fluid flow through the pressure regulator and to cause the wiper of the filter to wipe across the filter element in a first direction to clean the filter element, and a second setting permitting the valve to move away from the valve seat to permit and regulate flow through the pressure regulator and to cause the wiper to wipe across the filter element in a second direction to clean the filter element.

2. An apparatus in accordance with claim 1 wherein the control device defines a third inlet, a third outlet and a third passageway extending therebetween, the third inlet being in fluid communication with the second outlet for the filter and the third outlet being in fluid communication with the filter assembly, the control device further comprising a second valve and a second valve seat in the third passageway, the second valve of the control device being selectively moveable into engagement with the second valve seat of the control device to prohibit flow through the control device which in turn causes the first valve to engage the first valve seat of the pressure regulator to prohibit flow through the pressure regulator and to cause the wiper of the filter to wipe across the filter element, the second valve being selectively moveable away from the second valve seat of the control device to permit flow through the control device which in turn permits the first valve to move between various positions spaced from the valve seat to regulate flow through the valve seat.

3. An apparatus in accordance with claim 2 wherein the control device comprises a first spring to bias the second valve into engagement with the second valve seat of the control device and an electrically-actuated solenoid to move the second valve away from the second valve seat of the control device when electrically energized.

4. An apparatus in accordance with claim 1 wherein the pressure regulator, the filter assembly and the control device are incorporated into a single housing.

5. An apparatus in accordance with claim 1 wherein the pressure regulator further defines a lockout chamber and a first two-way port at the lockout chamber, the first two-way port in fluid communication with the second outlet of the filter and the third inlet of the control device, and comprises a first piston in sealing engagement with the lockout chamber, a first piston shaft extending into the first passageway to move the first valve relative to the first valve seat, wherein fluid pressure increase in the lockout chamber when fluid flow is prohibited through the control device causes the first piston to move the first valve to engage the first valve seat of the pressure regulator to prohibit flow through the pressure regulator, and a spring biases the first piston such that the first valve is permitted to move away from the first valve seat when the control device permits flow therethrough.

6. An apparatus in accordance with claim 5 wherein the pressure regulator further comprises a slide pin that interconnects the first piston shaft and the first valve to permit the first valve to move relative to the first valve seat and defines a system pressure chamber as part of the first passageway, a spring biased diaphragm being disposed in the system pressure chamber to operate a second shaft connected to the first valve to move the first valve relative to the first valve seat to permit regulated fluid flow through the pressure regulator.

7. An apparatus in accordance with claim 5 wherein the fluid communication between the second outlet and the first two-way port and the third inlet includes a restriction.

8. An apparatus in accordance with claim 6 wherein the pressure regulator defines a vent passage between the lockout chamber and the first passageway.

9. An apparatus in accordance with claim 1 wherein the filter assembly defines a control chamber having a second two-way port in fluid communication with the control device and a second piston seal capable of reciprocating movement in the control chamber, and has a second shaft interconnecting the second piston seal and the wiper such that reciprocating movement of the second piston seal causes reciprocating movement of the wiper across the filter element and a second spring disposed in the control chamber to exert a force on the second piston seal in a direction opposite to a hydraulic force exerted on the second piston seal from fluid in the control chamber.

10. An apparatus in accordance with claim 9 wherein fluid enters the control chamber through the second two-way port when the control device permits fluid flow therethrough, the fluid in the chamber causes the second piston seal to overcome the second spring bias and move the second shaft and the attached wiper across the filter to clean the filter, and when the control device prohibits flow therethrough, the second spring bias causes fluid to exit through the second two-way port and the wiper to wipe back across the filter to clean the filter.

11. An apparatus in accordance with claim 10 wherein the control chamber defines a vent port.

12. An apparatus in accordance with claim 1 wherein the filter assembly includes a discharge opening to allow selective discharge of foreign matter removed from the filter element.

13. An apparatus in accordance with claim 10 wherein the second shaft defines at least one groove that permits from material wiped from the screen to be discharged from the filter assembly.

14. An apparatus in accordance with claim 13 wherein the groove is an elongated groove that extends longitudinally along the shaft.

15. An apparatus in accordance with claim 14 wherein the groove permits material wiped from the screen to be discharged from the filter assembly when the second shaft is in an intermediate position where the groove extends from inside the filter assembly to outside of the filter assembly.

16. An apparatus in accordance with claim 1 wherein the filter element is a filter screen disposed in the passageway.

17. An apparatus in accordance with claim 16 wherein the filter screen is a cylindrical tube-like screen.

18. A method of providing water to an irrigation system comprising:
providing a flow of irrigation water;
providing a filter to remove particulate matter from the flow of irrigation water, thereby creating a flow of filtered water;
directing a first portion of the flow of filtered water to a solenoid-actuated control valve;
directing a second portion of the flow of filtered water to a pressure regulator;
delivering a flow of water from the pressure regulator to one or more irrigation devices; and
automatically cleaning the surface of a filter upon activation or deactivation of the irrigation system.

19. The method of claim 18 further comprising the step of:
using a flow of filtered water from the solenoid-actuated control valve to cause a scraper to scrape across a surface of the filter when the solenoid-actuated control valve is opened.

20. The method of claim 19 comprising the step of:
discarding filtered particulate material during a stroke of the scraper.

21. An apparatus for use in controlling fluid flow comprising:
a filter assembly defining a first inlet, a first outlet and a first passageway extending therebetween, and having a filter element and a wiper engaging the filter element to clean the filter element; and
a control device being in communication with the filter assembly and defining a second inlet, a second outlet and a second passageway extending therebetween, the second inlet being in fluid communication with the first outlet to filter the fluid entering the control device, the control device having at least two settings, a first setting in which fluid flows to the filter assembly from the control device to cause the wiper of the filter to wipe across the filter element in a first direction to clean the filter element and, and a second setting in which fluid is prohibited from flowing to the filter assembly from the control device to permit the wiper to wipe across the filter element in a second direction.

22. An apparatus in accordance with claim 21 wherein the control device further comprises a valve and a valve seat in the second passageway, the valve being selectively moveable into engagement with the valve seat in the second setting of the control device, and the valve being selectively moveable away from the valve seat in the first setting of the control device.

23. An apparatus in accordance with claim 22 wherein the control device comprises a first spring to bias the valve into engagement with the valve seat in the second setting of the control device and an electrically-actuated solenoid to move the valve away from the valve seat in the first setting of the control device when electrically energized.

24. An apparatus in accordance with claim 21 wherein the filter assembly and the control device are incorporated into a single housing.

25. An apparatus in accordance with claim 21 wherein the filter assembly defines a control chamber having a two-way port in fluid communication with the control device and a piston seal capable of reciprocating movement in the control chamber, and has a shaft interconnecting the piston seal and the wiper such that reciprocating movement of the piston seal causes reciprocating movement of the wiper across the filter element and a second spring disposed in the control chamber to exert a force on the piston seal in a direction opposite to a hydraulic force exerted on the piston seal from fluid in the control chamber.

26. An apparatus in accordance with claim 25 wherein fluid enters the control chamber through the two-way port when the control device is in the first setting, the fluid in the chamber causing the piston seal to overcome the second spring bias and move the shaft and the attached wiper across the filter to clean the filter, and when the control is in the second setting, the second spring bias causes fluid to exit through the two-way port and the wiper to wipe back across the filter to clean the filter.

27. An apparatus in accordance with claim 26 wherein the control chamber defines a vent port.

28. An apparatus in accordance with claim 21 wherein the filter assembly includes a discharge opening to allow selective discharge of foreign matter removed from the filter element.

29. An apparatus in accordance with claim 26 wherein the shaft defines at least one groove that permits material wiped from the screen to be discharged from the filter assembly.

30. An apparatus in accordance with claim 29 wherein the groove is an elongated groove that extends longitudinally along the shaft.

31. An apparatus in accordance with claim 30 wherein the groove permits material wiped from the screen to be discharged from the filter assembly when the shaft is in an intermediate position where the groove extends from inside the filter assembly to outside of the filter assembly.

32. An apparatus in accordance with claim 21 wherein the filter element is a filter screen disposed in the passageway.

33. An apparatus in accordance with claim 32 wherein the filter screen is a cylindrical tube-like screen.

34. An apparatus for use in controlling fluid flow comprising:
a pressure regulator defining a first inlet, a first outlet and a first passageway extending therebetween and having a first valve and a first valve seat in the first passageway, the first valve being moveable into engagement with the first valve seat to close the first passageway to prohibit fluid flow therethrough and various other positions spaced from the first valve seat to regulate flow through the first valve seat; and
a control device being in communication with the pressure regulator and having at least two settings, a first setting causing the first valve to engage the first valve seat to prohibit fluid flow through the pressure regulator, and a second setting permitting the valve to move away from the valve seat to permit and regulate flow through the pressure regulator.

35. An apparatus in accordance with claim 34 wherein the control device defines a second inlet, a second outlet and a second passageway extending therebetween, the second inlet being in fluid communication with a source of fluid and the second outlet being in fluid communication with the first outlet, the control device further comprising a second valve and a second valve seat in the second passageway, the second valve of the control device being selectively moveable into engagement with the second valve seat in the first setting of the control device to prohibit flow through the control device which causes the first valve to engage the first valve seat of the pressure regulator to prohibit flow through the pressure regulator, the second valve being selectively moveable away from the second valve seat in the second setting of the control device to permit flow through the control device which in turn permits the first valve to move between various positions spaced from the valve seat to regulate flow through the valve seat.

36. An apparatus in accordance with claim 35 wherein the control device comprises a first spring to bias the second valve into engagement with the second valve seat in the first setting of the control device and an electrically-actuated solenoid to move the second valve away from the second valve seat in the second setting of the control device when electrically energized.

37. An apparatus in accordance with claim 34 wherein the pressure regulator and the control device are incorporated into a single housing.

38. An apparatus in accordance with claim 34 wherein the pressure regulator further defines a lockout chamber and a two-way port at the lockout chamber, the two-way port in fluid communication with source of fluid and the second inlet of the control device, and comprises a piston in sealing engagement with the lockout chamber, a first piston shaft extending into the first passageway to move the first valve relative to the first valve seat, wherein fluid pressure increase in the lockout chamber when fluid flow is prohibited through the control device causes the piston to move the first valve to engage the first valve seat of the pressure regulator to prohibit flow through the pressure regulator when the control device is in the first setting, and a second spring biases the first piston such that the first valve is permitted to move away from the first valve seat when the control device is in the second setting.

39. An apparatus in accordance with claim 38 wherein the pressure regulator further comprises a slide pin that interconnects the first piston shaft and the first valve to permit the first valve to move relative to the first valve seat and defines a system pressure chamber as part of the first passageway, a spring biased diaphragm being disposed in the system pressure chamber to operate a second shaft connected to the first valve to move the first valve relative to the first valve seat to permit regulated fluid flow through the pressure regulator.

40. An apparatus in accordance with claim 38 wherein the fluid communication between the source of fluid and the two-way port and the second inlet includes a restriction.

41. An apparatus in accordance with claim 39 wherein the pressure regulator defines a vent passage between the lockout chamber and the first passageway.
